(19) United States
(12) Patent Application Publication
(10) Pub. No.: US 2010/0321506 A1
(43) Pub. Date: Dec. 23, 2010

(54) CALIBRATION TECHNIQUES FOR CAMERA MODULES

(76) Inventors: Wei Li, Cupertino, CA (US); Godfrey Chow, Fremont, CA (US); John Rowles, Cupertino, CA (US); Kyaw Min, San Jose, CA (US)

Correspondence Address: MARSH, FISCHMANN & BREYFOGLE LLP, 8055 East Tufts Avenue, Suite 450, Denver, CO, 80237, US

(21) Appl. No.: 12/716,128

(22) Filed: Mar. 2, 2010

Related U.S. Application Data
(60) Provisional application No. 61/156,692, filed on Mar. 2, 2009.

(51) Int. Cl. H04N 17/00

(52) U.S. Cl. 348/187; 348/E17.002

(57) ABSTRACT

A set of calibration procedures that can be run to assist in calibrating a camera module, such as may be intended for installation into a mobile consumer device. The procedures include lens shading calibration, white balance calibration, light source color temperature calibration, auto focus macro calibration, static defect pixel calibration, and mechanical shutter delay calibration. The light source color temperature calibration may be performed to assist in the other calibrations, each of which may generate data that can be potentially be stored in non-volatile memory on board the camera module for use during operation.

### CROSS-REFERENCE TO RELATED APPLICATION

This application claims priority under 35 U.S.C. 119 to U.S. Provisional Application No. 61/156,692, entitled: “CALIBRATION TECHNIQUES FOR CAMERA MODULES,” filed on Mar. 2, 2009, the contents of which are incorporated herein as if set forth in full.

### BACKGROUND

Digital camera modules are currently being incorporated into a variety of host devices. Such host devices include cellular telephones, personal data assistants (PDAs), computers, and so forth. Consumer demand for digital camera modules in host devices continues to grow.

Host device manufacturers prefer digital camera modules to be small, so that they can be incorporated into the host device without increasing the overall size of the host device. Further, host device manufacturers desire camera modules that minimally affect host device design. In addition, camera module and host device manufacturers want the incorporation of the camera modules into the host devices not to compromise image quality.

A conventional digital camera module generally includes a lens assembly, a housing, a printed circuit board or flexible circuit, and an image sensor. Upon assembly, the sensor is electrically coupled to the circuit. A housing is then affixed to either the circuit or the sensor. A lens is retained by the housing to focus incident light traveling through the lens onto an image capture surface of the sensor. The circuit includes a plurality of electrical contacts that provide a communication path for the sensor to communicate image data generated by the sensor to the host device for processing, display, and storage.

Image sensors are often formed of small silicon chips containing large arrays of photosensitive diodes called photosites (also referred to as a pixel). When an image is to be captured, each photosite records the intensity or brightness of the incident light by accumulating a charge; the more light, the higher the charge. The sensor sends the raw image data indicative of the various charges to the host device, where the raw image data is processed, e.g., converted to formatted image data (e.g., JPEG, TIFF, PNG, etc.) and to displayable image data (e.g., an image bitmap) for display to the user on, for example, an LCD screen. Alternatively, some sensors may do certain limited image processing onboard and send a JPEG file, for example, to the host device.

These photosites use filters to measure light intensities corresponding to various colors and shades. Typically, each individual photosite includes one of three primary color filters, e.g., a red filter, a green filter and a blue filter. Each filter permits only light waves of its designated color to pass and thus contact the photosensitive diode. Thus, the red filter permits only red light to pass, the green filter only permits green light to pass, and the blue filter only permits blue light to pass. Accumulating three primary color intensities from three adjacent photosites provides sufficient data to yield an accurately colored pixel. For example, if the red filter and the green filter accumulate a minimal charge and the blue filter accumulates a peak charge, the captured color must be blue. Thus, the image pixel may be displayed as blue.

After assembly, the camera module may be calibrated to known intensities of light through the color filters. One prior art method includes taking a picture of a color chart (e.g., MacBeth color chart) and running the image data through color correction processes. The recorded intensities are corrected to correspond to the known color intensities. This process can be done relatively quickly, because the color correction can be effected from a single exposure.

The typical color chart is manufactured from colored dyes. Unfortunately, calibration using the typical color chart results in substandard calibration for those colors not present in dyes. The conventionally calibrated camera module has difficulty measuring other natural colors not provided by the color chart.

Some camera module manufacturers calibrate camera modules using a device called a monochromator. A monochromator sends light through a prism to output a predetermined color. Then, a picture of the predetermined color is taken. The camera module is then calibrated to the known intensity of the particular color. The process is repeated for another color, for an estimated 24 colors or more. Although the monochromator facilitates the calibration of natural colors, it has disadvantages. Such devices are relatively expensive. Also, several pictures must be taken, one for each color to be calibrated. This compromises manufacturing throughput, increases time-to-market, and increases overall manufacturing cost.

The foregoing examples of the related art and limitations related therewith are intended to be illustrative and not exclusive. Other limitations of the related art will become apparent to those of skill in the art upon a reading of the specification and a study of the drawings.

### BRIEF DESCRIPTION OF TILE DRAWINGS

FIG. 1 is a schematic of a calibration set-up including a camera module to be calibrated and a calibration apparatus.

FIG. 2 is a process flow of an auto focus macro calibration procedure.

FIG. 3 is a schematic of a set-up for the auto focus macro calibration procedure.

FIG. 4 is an illustration of some defective pixels.

FIG. 5 is an illustration of a scanning pattern for looking for defective pixels.

FIG. 6 is a Bayer image file showing defective pixels.

FIG. 7 is a table showing the correction for defective pixels.

FIG. 8 shows a scanning area used in the mechanical shutter delay characterization procedure.

### DETAILED DESCRIPTION

The following description is not intended to limit the invention to the form disclosed herein. Consequently, variations and modifications commensurate with the following teachings, and skill and knowledge of the relevant art, are within the scope of the present invention. The embodiments described herein are further intended to explain modes known of practicing the invention and to enable others skilled in the art to utilize the invention in such, or other embodiments and with various modifications required by the particular application(s) or use(s) of the present invention.

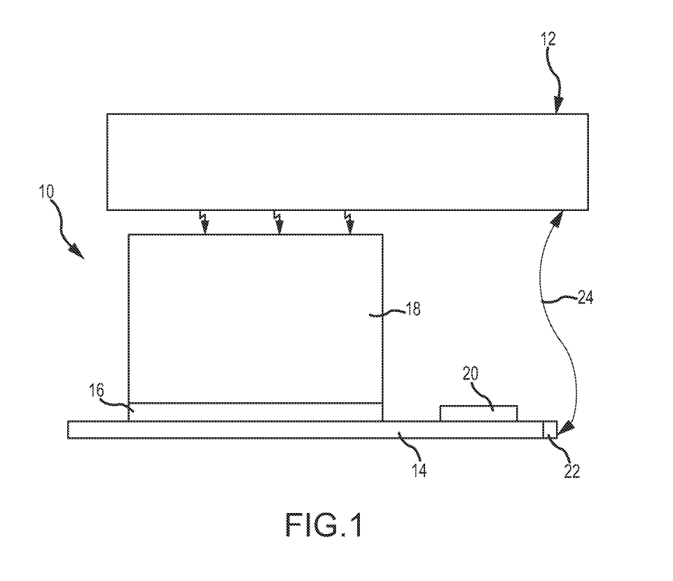

FIG. 1 shows a camera module 10 that can be operated with a calibration apparatus 12 as discussed herein. The camera module 10 includes a substrate or circuit board 14 (such as a flexible printed circuit board) onto which an image sensor 16 is mounted. A lens housing or barrel 18 is mounted to the sensor 16 or to the circuit board 14. As is shown, the camera module 10 is receptive of light from the calibration apparatus 12. Further, the image sensor 15 may be a system on a chip (SoC) or it may interact with a separate image processor residing on or off the camera module 10. In this case, a separate processor 20 is shown on the camera module. This processor 20 may have associated with it non-volatile memory located internally or externally or, as discussed above, the memory may be located in the SoC sensor or be associated therewith. In addition, the camera module may have a connector 22 located thereon for connection to external devices such as the mobile consumer device that the camera module is to be installed in, or to test equipment such as the calibration apparatus 12 such as via electrical cable 24, although any other means of coupling between the calibration apparatus 12 and the camera module 10 could be employed such as wireless communication.

It is contemplated that one or more of the following calibration procedures (and potentially others as well) will be performed on each camera module after or as part of the camera module assembly process. The proCedures will each generate calibration data that will be transferred to and stored in non-volatile memory (e.g., flash memory, EEPROM, One Time Programmable Memory, aka OTPM or other suitable memory type) in the camera module, potentially on the image sensor. Subsequently, once the camera module is installed in a host device, the calibration data can be used in generating image data for the host device. Some of the various calibration procedures will now be discussed.

### Lens Shading Calibration Procedures

Lens shading is the phenomenon of a variation in brightness of the image from one portion of the image to another portion. This can be caused by a variety of factors including non-uniform illumination, off-axis illumination, non-uniform sensitivity of the image sensor, optical design of the camera, or contaminants on all or a portion of the camera optics. There are three major operations to the lens shading calibration procedure. In a first operation, a 10 bit Bayer pattern image of an ideal light source is captured. In a second operation, a lens shading curve is generated in a format appropriate for the memory map which may be specific to an image signal processor (ISP). The ISP used in an exemplary host device is made by Fujitsu and the procedures described herein are compatible with such an ISP or SoC-based image sensors. In a third operation, calibration binary data is generated and flashed to the camera module for storage in non-volatile memory such as flash memory.

### Operation 1: Capture 10 Bit Bayer Image

Setup: Tsubosaka light box with LV set to 10.0. Fujitsu host board with Filipa test key set up with FoV fully inside the Tsubosaka light box illuminated area. Following category commands are entered to set up the M5MO:

| | |
|---|---|
| Lens shading off | w2 1 7 0 |
| Disable SUPPRE | W2 1 1c 2 |
| EV compensation | w2 3 9 2D; +1.5 EV |
| | +1.5 EV |
| Capture Bayer | Cap bayer/text |

Note that when the exposure level is set correctly, the average green at the center is around 750 on 10 bit scale.

### Operation 2: Generate Lens Shading Curve

1. Install DevWare from eRoom: version: 2.11-alpha10
2. Copy run_lenscalib.bat and xlate.exe in the directory where Bayer image resides
3. Edit run_lenscalib for all names
4. Double click file
5. Output.txt contains lens shading curve, to be copied to Adjust.xls
Operation 3: Generate calibration data file

### 1. Install Excel 2007

2. Open Output.txt, select all, copy all
3. Copy into the lens shading table 1.
4. Enable macro, click on create individual file

In factory, the .INI are generated by Manufacturing Test SW and directly written to flash.

Map_adj.bin contains the lens shading calibration data. To flash it to the module, copy the file to flash card M5MO directory. Enter in hyperterminal:

### Fw/rf

Note: when reflashing modules with newer software, one should use

### Fw/rcd

So that calibration data is preserved.

### White Balance Calibration Procedures

There are two major steps to the white balance calibration procedure. In a first step, a 10 bit Bayer pattern image of an ideal light source is captured. In a second step, white balance calibration gains are calculated. White balance calibration is performed after lens shading calibration has been performed and using the lens shading calibration data.

### Operation 1: Capture 10 Bit Bayer Image

Setup: Tsubosaka light box with LV set to 10.0. Fujitsu host board with Filipa test key set up with FoV fully inside the Tsubsaka light box illuminated area. Note that no EV compensation is needed.

| | |
|---|---|
| Enter parameter | 4; |
| | boot; |
| mode | mode par |
| Disable SUPPRE | W2 1 1C 2 |
| Manual Exposure | W2 3 1 0 |
| Enter monitor | Mode mon |
| mode | |
| Capture Bayer | Cap bayer/text |

### Operation 2: Generate White Balance Gains

The white balance calibration tries to shoot target of certain R, G, B values for the measured on gold modules. The current R, G, B targets of Bayer pattern is as follows:

### Rₜ=150, Gₜ=265, Bₜ=245.

From the 10 bit R, G, B, compute average Rₘ, Gₘ, Bₘ, values of the center square 256×256 out of 2608×1960. Note that Gₘ is average of Gr and Gb channels.

We maintain calibration gain of green channels to be 1.0. So gain_g=0x0100. The calibration gain on red, and blue channels can be then calculated as:

gain_{—}r=INT((256*Rₜ*Gₘ)/(Gₜ*Rₘ))

Where INTO converts value to integer. Note that value written to the memory map should be in HEX.

Similarly, we can compute:

gain_{—}b=INT((256*Bₜ*Gₘ)/(Gₜ*Bₘ))

Please note that ProGain Draft (monitoring mode), ProGain Still (capture mode) and ProGain AddPixel (binning in monitor mode) should write the same channel gains.

### Operation 3: Generate Calibration Data File

1. Install Excel 2007
2. Copy all gain_r, gain_g and gain_b values to the corresponding cells in M5Mo_MemMap_Adjust.xls
3. Enable macro, click on create individual file
   Map_adj.bin contains the white balance calibration data. To flash it to the module, copy the file to flash card M5MO directory. Enter in hyperterminal:

### Fw/rf

Note: In factory, calibration data is written to the flash directly without going through the spread sheet.

The memory map address for the red gain and blue gains are following different orders pre and after release 2.50.

| FW Version | Pre V2.50 | V2.50 and later |
|---|---|---|
| 0x16 | gain_gr | gain_r |
| 0x18 | gain_r | gain_gr |
| 0x1A | gain_b | gain_gb |
| 0x1C | gain_gb | gain_b |
| 0x1E | gain_gr | gain_r |
| 0x20 | gain_r | gain_gr |
| 0x22 | gain_b | gain_gb |
| 0x24 | gain_gb | gain_b |
| 0x26 | gain_gr | gain_r |
| 0x28 | gain_r | gain_gr |
| 0x2A | gain_b | gain_gb |
| 0x2C | gain_gb | gain_b |

### Light Source Color Temperature Calibration

Color temperature of each light box may be slightly different. This may affect the precision of the white balance calibration. Each light box should be calibrated at the start of the project, and when the light bulb is changed. The calibration is performed by adjusting the R, G, B target so that each light box will generate the same calibration results using the same module. Assume Rₜ, Bₜ are targets using the gold light box (the one used to generate white balance tuning), and R_{c}, G_{c}, B_{c} are targets using the light box to be calibrated. Assume a unit has already been calibrated on the target light box. Without erasing the white balance calibration, perform the white balance calibration again on gold light box and generate results gain_r_{c}, gain_b_{c}. Set constraint G_{c}=Gₜ, then

R_{c}=Rₜ*gain_{—}r_{c}/256

B_{c}=Bₜ*gain_{—}b_{c}/256

For example, we have

### Rₜ=150

### Gₜ=265

### Bₜ=245

gain_r_{c}=0xF8=0d248

gain_b_{c}=0xF8=0d248

### Then

### R_{c}=145

### G_{c}=265

### B_{c}=237

### Auto Focus Macro Calibration Procedure

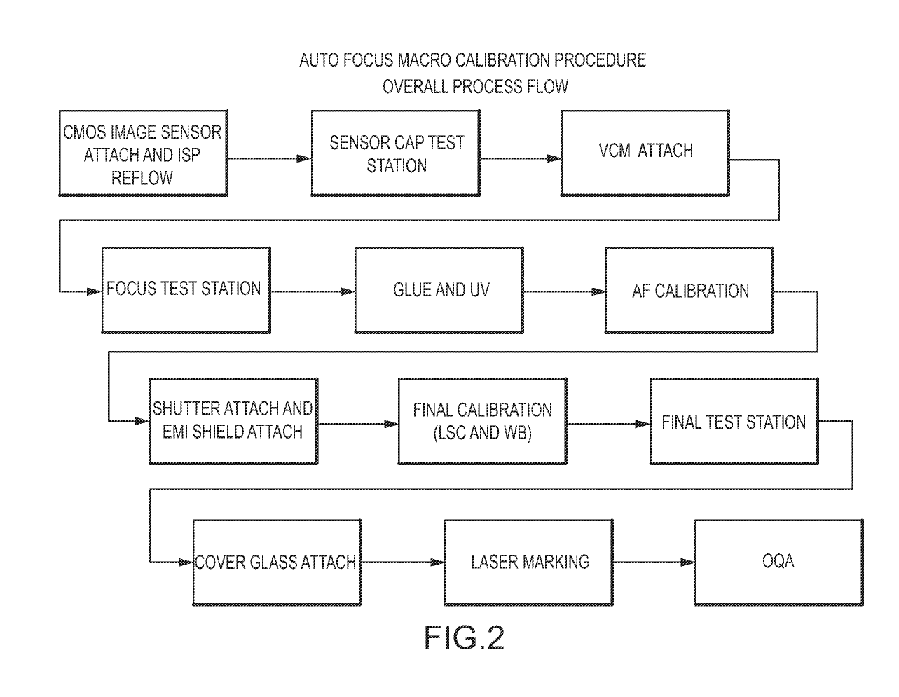

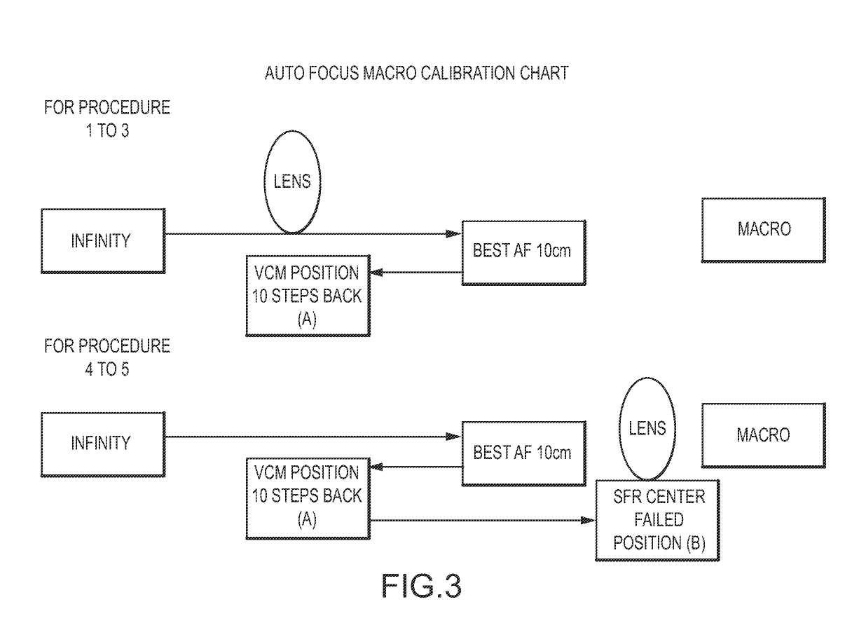

FIG. 2 shows an overall process flow for the auto focus macro calibration procedure and FIG. 3 shows a schematic of the procedure set-up.

### For AF Calibration Station

1. Set macro mode AF command.
2. Trigger Auto Focus to the near field target (10 cm).
3. Manually step back 10 VCM position steps (A).
4. Sweep thru the VCM position steps starting from (A) to Macro position until the SFR center score failed.
5. Record the VCM position steps (B) when the SFR center score failed.
6. Record the best SFR center score during the sweep.
7. Write both information from 5 and 6 into memory map area x1FA000.

### For Calibration Station

8. Read the VCM position steps (B) from memory map area x1FA000.
9. Write it back to memory map area x1FA006.

### Static Defect Pixel Correction Calibration

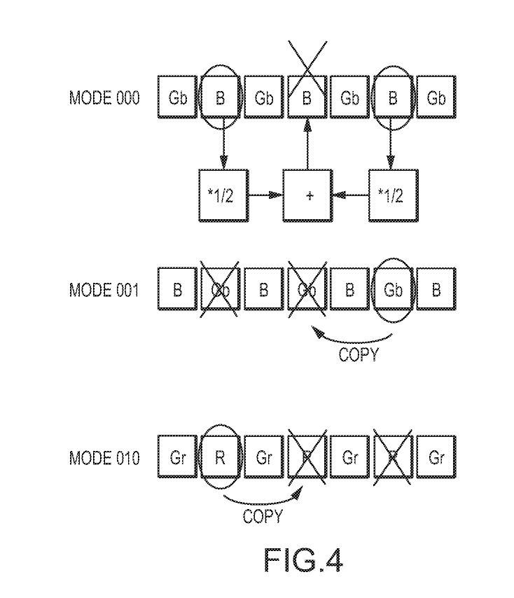

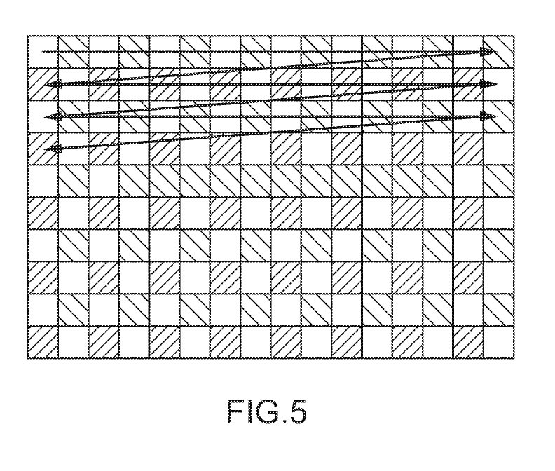

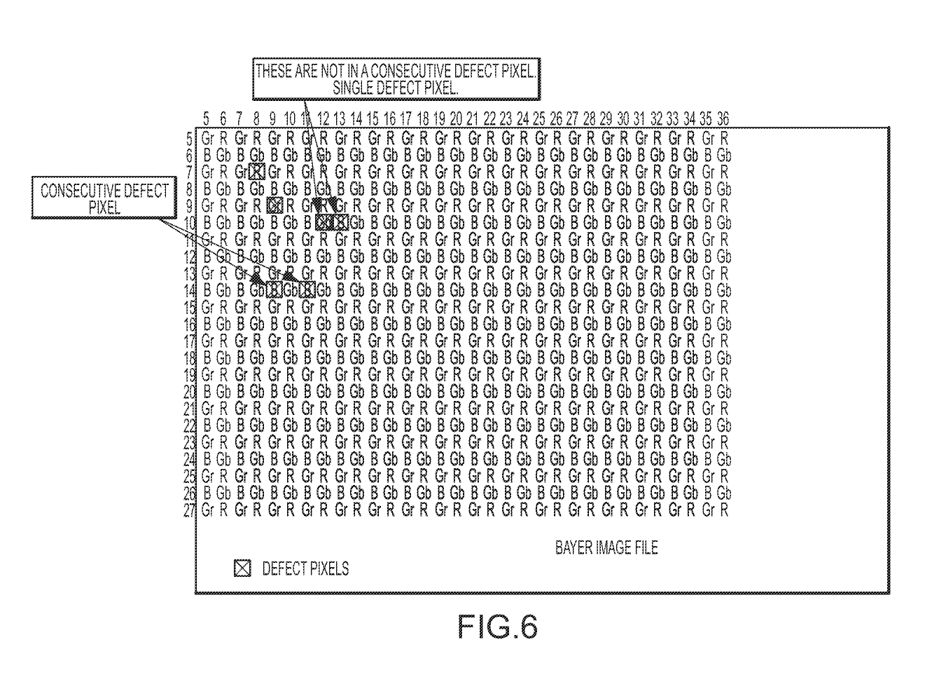

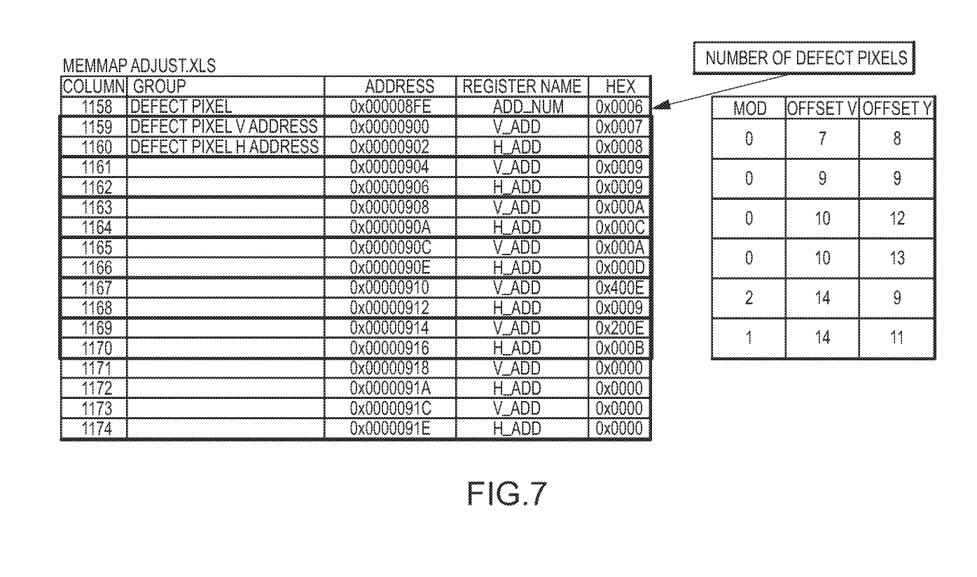

FIG. 4 shows an illustration of defective pixels and how such defective pixels are handled.
1. Capture a RAW Bayer image with the sensor using a light field target. The lighting condition should be midlevel, if image is too dark or saturated then it may allow defect escapes. Basically the same setup as the Particles Test.
2. Extract each color plane from the Bayer image. This is needed because of the following reasons:
   a. The variation of means on each color plane would lead to false passes or detections of defective pixels.
   b. The MODE settings in (see 5) are based on looking for defects of the same color plane.
3. Run particles test algorithm on each color plane. The ROI should be set to half of the primary Particles Test ROI for better correlation. For example, if the ROI in the Particles Test in Sensor Cap station is set to 32 pixels then the ROI in the separated color plane should be 16 to correspond with same area. The thresholds should be the same as Particles Test or broader due to the higher level of pixel to pixel variance in Bayer image.
4. Collect the list of (y,x) coordinates of each defective pixel detected in an array in order of vertical(y) coordinate. Also set up a third parameter within the array for each coordinate to store the MODE setting (for use in Step 5).
5. For each defective pixel, check the previous and next defect coordinate to determine whether they are directly to the left or right of the current pixel. This will determine the MODE setting. If a defective pixel has a defect to the left of it, it will have a MODE of 1. If a defect has a defective pixel to the right of it, it will have a MODE of 2. While having no defects on either side will mean it is a MODE of 0. However, if a defective pixel has defects present on both right and left sides then it cannot be repaired with the current firmware and its coordinate should be ignored for the remainder of the test. For more information on MODE settings and Static Pixel Correction please refer to the document Statistical_DefectPixelCorrection_in JDSPRO.pdf in the Fujitsu section of eRoom.
   FIG. 4 shows how each mode corrects the defect pixel in the center. With this system MODE 0 is the most accurate defect correction.
6. Once all coordinates and MODE settings for all color planes are determined they must be translated into the coordinates of the full Bayer image and combined together. The list of coordinates must be sorted in scan order (See FIG. 5 for example). Note that currently 256 is the maximum number of defective pixels that can be corrected. The preferred method would be to prioritize on defects in the central area while leaving outer edges as lower priority corrections (this is not available in the current implementation).
7. All coordinates must be offset by +5 for the true Bayer array coordinate before it can be written to the memory map.
8. The defect pixel register addresses begin at address 0x0001F8FE.
9. Set ADD_NUM (0x0001F8FE) to the number of defective pixels to correct, maximum of 256. Then set rest of the addresses to the list of defective pixel coordinates. V_ADD is the vertical(y) component and H_ADD is the horizontal(x) component. The 3 MSBs of V_ADD are reserved for the MOD. See FIGS. 6 and 7 for an example:
10. Before capturing any images after writing the corrections into the memory map, set Category 2, Byte 0x04 (STNR_EN) to 0x01 to set the pixel correction on. As of firmware version 3.1 the static pixel correction works in stream capture. Any prior firmware releases up to 2.65 should rely on capture mode to properly view the corrections.
11. Rerun the Particles Test to ensure that the defect correction fixed all the particles. It is recommended that you leave Dynamic Defect Correction on during this test to see the image with all corrections for increased yield.
12. In order to translate Static Defective Pixel Correction coordinates in the memory map to YUV image, add an (x,y)=(−10,−14) offset. For JPEG capture this offset is (−14,−14).

### Filippa Calibration of Mechanical Shutter Delay

Parameter

| Light Value | F Number | Shutter Speed (sec) | ISO |
|---|---|---|---|
| 12.0 | 2.8 | 1/500 | 100 |

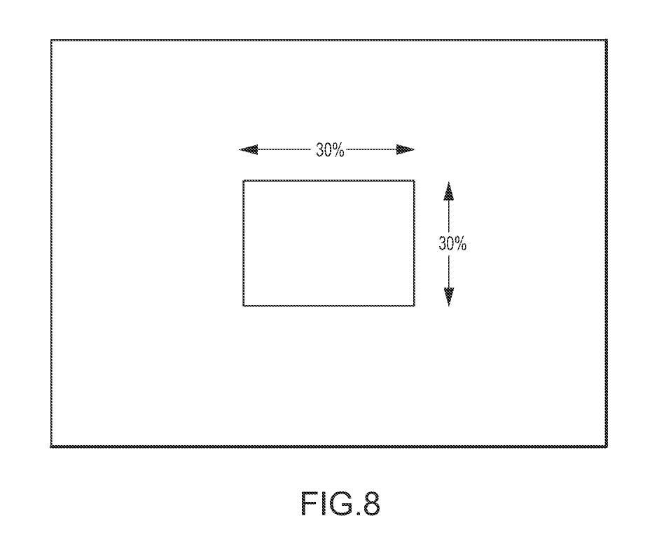

Above parameters are used to capture an image when it is necessary to calibrate mechanical shutter delay. Light Value is the number on the Light Box value. FIG. 8 shows the evaluation area for exposure value. It is calculated the average data from Green 1/9 area in a whole image.

Any other combination of all the techniques discussed herein is also possible. The foregoing description has been presented for purposes of illustration and description. Furthermore, the description is not intended to limit the invention to the form disclosed herein. While a number of exemplary aspects and embodiments have been discussed above, those of skill in the art will recognize certain variations, modifications, permutations, additions, and sub-combinations thereof. It is therefore intended that the following appended claims and claims hereafter introduced are interpreted to include all such variations, modifications, permutations, additions, and sub-combinations as are within their true spirit and scope.

1. A method for operating a camera module for use in portable consumer devices, comprising:
operating the camera module to obtain an image of an optical target having known optical characteristics;
calculating corrective data for the camera module based on the captured image and the known optical characteristics;
storing the corrective data in non-volatile memory associated with the camera module; and
operating the camera module with the corrective data to generate a corrected image.

2. A method as defined in claim 1, wherein the non-volatile memory is located in the camera module.

3. A method of calibrating a camera module, the camera module being for use in portable consumer devices, the method comprising:
obtaining an image of a light source that has known optical characteristics;
generating a lens shading curve in relation to a memory map; and
storing information representative of the lens shading curve in relation to the memory map in non-volatile memory associated with the camera module.

4. A method as defined in claim 3, further including operating the camera module and utilizing the stored information to generate a corrected image.

5. A method of calibrating a camera module, the camera module being for use in portable consumer devices, the method comprising:
obtaining an image of a light source that has known optical characteristics;
calculating white balance gains based on the captured image and the known optical characteristics; and
storing information representative of the white balance gains in non-volatile memory associated with the camera module.

6. A method as defined in claim 5, further including operating the camera module and utilizing the stored information to generate a corrected image.

7. A method as defined in claim 5, further including performing a color temperature calibration of the light source.

8. A method of calibrating a camera module, the camera module being for use in portable consumer devices, the method comprising:
setting the camera module to auto focus on a near field (macro) target that has known optical characteristics;
moving the focus position of the camera module a predetermined number of steps away from the near field (macro) position;
capturing a series of images of the target as the focus position is stepped toward the near field (macro) position;
determining the focus position that gave the best image;
storing information representative of the focus position that gave the best image of the near field (macro) target in non-volatile memory associated with the camera module.

9. A method as defined in claim 8, further including operating the camera module and utilizing the stored information to select a near field (macro) focus position.

10. A method as defined in claim 8, further including determining the focus positions where an acceptable image was not obtained

11. A method of calibrating a camera module, the camera module being for use in portable consumer devices, the method comprising:
obtaining an image of a light source that has known optical characteristics;
separately calculating, for each of three colors of the image, the locations of each defective pixel; and
storing information representative of defective pixel locations in non-volatile memory associated with the camera module.

12. A method as defined in claim 11, further including operating the camera module and utilizing the stored information to generate a corrected image.

13. A method as defined in claim 11, wherein if the adjacent pixels for that same color on either side of the defective pixel are not defective then the value for the defective pixel shall be a function of the adjacent pixels.

14. A method as defined in claim 13, wherein the function of the adjacent pixels is the average value of the adjacent pixels of the same color.

15. A method as defined in claim 11, wherein if the adjacent pixels for that same color on either side of the defective pixel is defective then the value for the defective pixel shall be the value of the non-defective adjacent pixel of the same color.

16. A method of calibrating a camera module, the camera module being for use in portable consumer devices, the method comprising:
setting the camera module to capture an image as a relatively fast f number and shutter speed;
obtaining an image of a light source that has known optical characteristics;
calculating the mechanical shutter delay based on the f number, shutter speed, and the known optical characteristics; and
storing information representative of the mechanical shutter delay in non-volatile memory associated with the camera module.

17. A method as defined in claim 16, further including operating the camera module and utilizing the stored information to generate a corrected image.
